(19) United States
(12) Patent Application Publication
(10) Pub. No.: US 2026/0183767 A1
(43) Pub. Date: Jul. 2, 2026

(54) OVEN MIXING SYSTEM AND METHOD FOR PHASE BEHAVIOR TESTS

(71) Applicants: CNPC USA Corporation, Houston, TX (US); Beijing Huamei, Inc., Beijing (CN); China National Petroleum Corporation, Beijing (CN)

(72) Inventors: Nancy Zhou, Katy, TX (US); Meng Lu, Katy, TX (US); Steven Vaughan, Katy, TX (US); Angel Vincent Feliciano, Houston, TX (US); Jianshen Li, Beijing (CN); Qing Liu, Beijing (CN)

(73) Assignees: CNPC USA Corporation, Houston, TX (US); Beijing Huamei, Inc., Beijing (CN); China National Petroleum Corporation, Beijing (CN)

(21) Appl. No.: 19/006,879

(22) Filed: Dec. 31, 2024

(51) Int. Cl. B01L 9/00; B01L 7/00; F27D 3/00

(52) U.S. Cl. CPC B01L 9/54; B01L 7/00; F27D 2003/0089

(57) ABSTRACT

An oven mixing apparatus includes an oven capable of generating heat, a pipette tray positioned inside the oven, and a motor. The pipette tray of the oven mixing apparatus includes pipette clamps attached to the pipette tray via fasteners, one or more arms, and a pipette tray axle. The motor of the oven mixing apparatus includes a portion of the motor inside the oven, a portion of the motor outside of the oven, a shaft rotatable via a rotor of the motor, and a controller capable of controlling rotational speed of the shaft.

### BACKGROUND

### 1. Field of Disclosure

Embodiments of the present disclosure relate to phase behavior tests for fluids related to oil and gas operations, and particularly, embodiments relate to an oven mixing apparatus to facilitate phase behavior tests.

### 2. Description of Related Art

In the later stages of oil and gas extraction operations in subterranean hydrocarbon reservoirs, it is common for Enhanced Oil Recovery (EOR) techniques to be employed. EOR is a set of techniques used to maximize the amount of oil recovered from an oil reservoir, often used to extract additional oil from a reservoir after other methods have been exhausted. Particularly, EOR focuses on improving the recovery efficiency of the remaining oil after the initial production phases in the formation. There are different types of EOR, such as: thermal recovery, which usually involves injecting heat into the reservoir; gas injection, which uses gases like carbon dioxide to increase production; and chemical injection, where chemicals like surfactants are injected into the reservoir.

With EOR involving the injection of surfactant formulations, it is helpful to understand how various surfactant formulations will affect oil recovery. Often, this involves testing the surfactant formulations in a laboratory setting. One such test that may be performed is a phase behavior test (PBT), which is used to understand how surfactants interact with crude oil, brine, and other substances present in an oil and gas reservoir, under reservoir conditions. Particularly, a PBT may identify whether the mixture of the surfactant formulation and the other fluids forms microemulsions, which are useful in reducing interfacial tension and improving oil recovery.

Common systems and methods of performing PBTs include manually mixing various types and concentrations of surfactant formulations with representative reservoir crude oil samples. The resulting mixtures are typically placed in small pipette tubes to hold the various test mixtures. The pipettes are allowed to equilibrate over a period of time, and different phases result, such as an oil phase, a water phase, and a microemulsion phase. Often, these existing systems and methods of PBTs may take an extensive amount of time for emulsions to form, may not be able to tolerate very high temperatures, and may be susceptible to human error and a lack of repeatability of testing results. There also may be safety concerns with existing methods of performing PBTs. In systems and methods that employ manual mixing, it may take upwards of 20 to 30 days in order for emulsions to form. This long period of time can slow down the overall testing timeline, as it takes more time to test the formulations and determine whether the formulations are effective.

### SUMMARY

Applicants recognized the problems noted above herein and conceived and developed embodiments of systems and methods, according to the present disclosure, for an oven mixing fixture system for phase behavior testing.

In an embodiment, an oven mixing apparatus includes an oven capable of generating heat, the oven having an interior and an exterior, a pipette tray positioned in the interior of the oven, and a motor. The pipette tray includes pipette clamps attached to the pipette tray via fasteners. The pipette tray further includes arms and a pipette tray axle. The motor includes an internal motor portion positioned in the interior of the oven, an external motor portion positioned exterior to the oven, a rotor, a shaft rotatable via the rotor, and a controller capable of controlling rotational speed of the shaft. The pipette tray axle of the pipette tray is securable to the shaft of the rotor, and rotation of the shaft induces rotation of the pipette tray.

In another embodiment, a method for performing a phase behavior test includes preparing surfactant formulations, mixing the surfactant formulations with an oil sample to create test mixtures, placing the test mixtures in containers, securing the containers to a tray, and placing the containers and the tray in an apparatus that includes a motor, and a shaft of a rotor is attachable to the tray. The method for performing a phase behavior test further includes rotating the containers via power supplied to the motor, generating heat within the apparatus to increase temperature of the test mixtures, analyzing the containers to determine whether the containers contain microemulsions, and analyzing phase separations in the containers.

In an embodiment, a method of using an oven mixing apparatus includes preparing surfactant formulations, mixing the surfactant formulations with an oil sample to create test mixtures, placing the test mixtures in pipettes, and placing the pipettes in the oven mixing apparatus that includes an oven comprising an interior and an exterior, a pipette tray positioned in the interior of the oven, and a motor. The pipette tray of the oven mixing apparatus includes pipette clamps attached to the pipette tray, and the pipettes are secured to the pipette clamps. The motor includes an internal motor positioned in the interior of the oven and an external motor portion positioned exterior to the oven. The method further includes increasing ambient temperature of the interior of the oven and rotating the pipette tray via a rotor.

### BRIEF DESCRIPTION OF DRAWINGS

The present technology will be better understood on reading the following detailed description of non-limiting embodiments thereof, and on examining the accompanying drawings, in which:

FIG. 1 is a top perspective view of an embodiment of an empty pipette tray of an oven mixing apparatus, in accordance with embodiments of the present disclosure;

FIG. 2 is a top perspective view of an embodiment of a pipette tray of an oven mixing apparatus having pipettes, in accordance with embodiments of the present disclosure;

FIG. 3 is an isometric cross-sectional view of internal features of an embodiment of an oven mixing apparatus, in accordance with embodiments of the present disclosure;

FIG. 4 is a perspective view of certain internal components of an embodiment of an oven mixing apparatus, in accordance with embodiments of the present disclosure;

FIG. 5 is a side perspective view of certain external components of an embodiment of an oven mixing apparatus motor, in accordance with embodiments of the present disclosure;

FIG. 6 is a flow chart of an embodiment of a method for performing a phase behavior test, in accordance with embodiments of the present disclosure; and

FIG. 7 is a flow chart of an embodiment of a method using an oven mixing apparatus, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/-10 percent.

Furthermore, like numbers may be used to refer to like elements throughout, but it should be appreciated that using like numbers is for convenience and clarity and not intended to limit embodiments of the present disclosure. For example, one or more subsequent figures may share similar features with one or more prior figures and the similar features may be identified with like reference numerals for convenience purposes only and not to limit the scope of the present disclosure.

Previously, PBTs for analyzing the efficacy of surfactant formulations required a significant amount of time. Therefore, determining effective surfactant formulations for EOR may be a time-consuming process, due to how long it took for emulsions to form, so one must wait a considerable amount of time to collect results. Additionally, in performing PBTs in the context of analyzing surfactant formulations for use in EOR, more accurate results may be obtained if the PBTs are conducted at reservoir conditions (e.g., high temperatures). Previously, oven mixing fixtures for facilitating PBTs had to use components (such as plastic or steel racks) that may not be able to withstand high temperatures. Therefore, the temperatures at which formulations could be tested were previously constrained by the materials that had to be placed within an oven for heating test mixtures.

Embodiments of the present disclosure are directed toward an oven mixing apparatus. The oven mixing apparatus may be used to conduct phase behavior tests (PBTs), however, it should be appreciated that the apparatus may also be used in other contexts, such as to mix and/or heat blood or biological specimens. PBTs may be performed to analyze the effectiveness of various surfactants or combinations of surfactants in creating microemulsions when mixed with oil samples, in order to increase oil extraction from reservoirs during Enhanced Oil Recovery (EOR) techniques. PBTs may be performed using the oven mixing apparatus in order to simulate reservoir conditions, such as the temperature and the mixing from injection of chemicals downhole into an oil and gas reservoir.

In various embodiments, the oven mixing apparatus may include an oven, a tray within the oven, and a motor. In one or more embodiments, the tray may include clamps attached to the tray, and the clamps may hold pipettes or vails containing test mixtures. It should be appreciated that the test mixtures may also be generally placed in containers of any reasonably suitable type, and the size or shape of the clamps may be altered in order to accommodate containers of different sizes, weights, and shapes.

In some embodiments, the tray may include wiring harnesses designed to hold the containers securely in place. The wiring harnesses may improve the safety of performing a PBT by ensuring the pipettes remain securely in place during tray rotation or other movement. The tray may further include an axle that is capable of attaching to the motor in order for the tray to be rotated by a rotor, thereby rotating or spinning the samples within the oven. The attachability of the tray to the motor within the oven allows the entire tray to be removable from the oven mixing apparatus. The rotation or spinning induced by the motor causes the contents of the containers to be mixed thoroughly, which helps simulate the environment during downhole injection into an oil and gas reservoir.

Embodiments of methods of the present disclosure may include preparing surfactant formulations. The surfactant formulations may comprise a single surfactant or a combination of two or more surfactants. The surfactant formulations may also contain different concentrations of surfactants to non-surfactant components and may also contain different concentrations of one surfactant to another surfactant. Additionally, methods may include mixing the surfactant formulations with an oil sample that is representative of an oil and gas reservoir to create test mixtures. The surfactants may be mixed in different amounts relative to the oil sample in order to test amounts of surfactant needed. Moreover, methods may include placing the test mixtures in containers (e.g., pipettes or vials). Methods may further include sealing the one or more pipettes or vials. Sealing may be performed so that the test mixtures do not spill into the oven or onto the tray during rotation, and to ensure the integrity of the results of the PBT. The pipettes or vials may include a pointy end and a non-pointy end and may be sealed from one or both ends. The pipettes or vials may also be sealed from one of the ends, then filled with the test mixtures, then sealed from the other end. Methods may further include recording the aqueous levels of the test mixtures once placed in the pipettes or vials.

Furthermore, methods may include placing the pipettes or vials in the oven mixing apparatus. Methods may also include increasing the ambient temperature of the interior of the oven. The temperature within the oven may be any temperature in the range of room temperature to approximately 400 degrees Fahrenheit. In at least one embodiment, the ambient temperature of the oven interior may be determined based on the surfactant formulation being tested and may also be based on the oil and gas reservoir that the oil sample is representative of. This technique may be performed in order to get results that are predictive of the success of the formulation when used in a practical implementation (i.e., when the formulation is actually injected into an oil and gas reservoir). In various embodiments, methods may further include rotating the tray via the rotor. The rotation may be constant or intermittent, may be unidirectional or multidirectional, and may switch directions after different periods of time.

Methods for performing the PBT may further include analyzing the contents (i.e., the test mixtures) of the pipettes or vials after heating and mixing in the oven to determine whether microemulsions have formed. If no microemulsions have formed, the containers may be placed back into the oven mixing apparatus for further rotation and heating. If microemulsions are observed as being formed, the heating by the oven and rotating by the motor may be ceased, and the tray may be removed from the oven mixing apparatus. Methods may further include analyzing phase separations in the containers and may include noting the levels of different phase separations in the pipettes or vials. The analyzing may be performed by visibly looking for phase separations or may be performed using analytical techniques (e.g., microscopy or spectroscopy) to determine phase behavior. Furthermore, methods may further include comparing the aqueous levels of the test mixtures within the pipettes or vials from before the PBT to the levels of the phases of the liquids after the heating and mixing process within the oven mixing apparatus.

In some embodiments, methods may also include mixing or shaking the test mixtures, either manually or by a mechanical means. The mixing or shaking may be performed before placing the containers in the apparatus; it also may be performed regularly during the process of the test mixtures creating emulsions. In one or more embodiments, methods may also include rotating the tray at approximately 2 revolutions per minute (RPM) up to approximately 15 RPM. In another embodiment, methods may also include rotating the tray at approximately 1 RPM up to approximately 100 RPM. In another embodiment, methods may also include rotating the tray at approximately 0 RPM up to approximately 500 RPM. It should be appreciated that the rotation speed may be greater than 500 RPM. Rotation speed may also be varied over the course of the rotational process in the oven mixing apparatus.

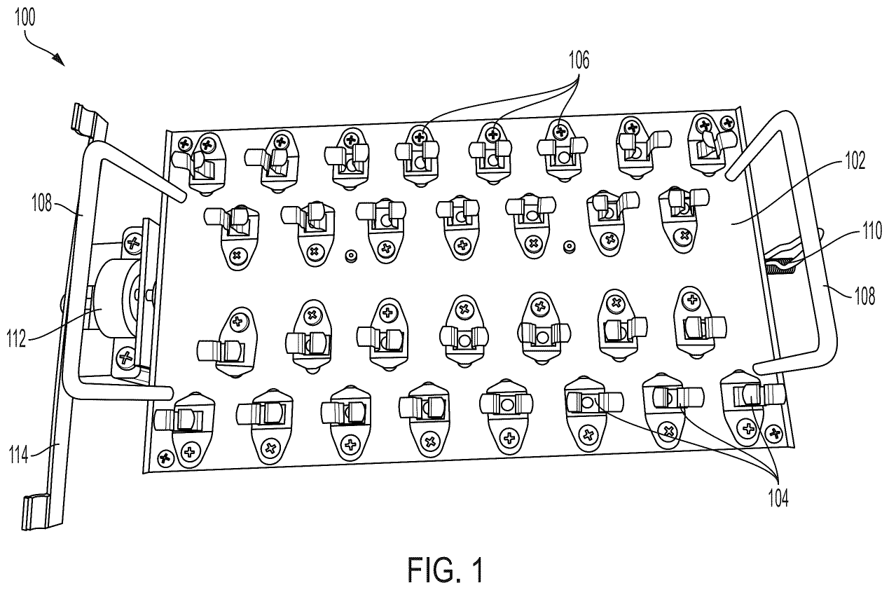

FIG. 1 is a top perspective view of tray components 100 removed from an oven mixing apparatus. Various components have been removed for simplicity with the present discussion, but additional components may be used with the tray components 100 as well. The tray components 100 include a pipette tray 102. It should be appreciated that although the illustrated tray is designed for pipettes, other types of containers or vials may be used in the tray. Attached to the tray 102 are one or more pipette clamps 104 for holding or otherwise securing pipettes (not illustrated in FIG. 1). It should be appreciated that although there are thirty pipette clamps 104 in the embodiment shown in FIG. 1, there may be any reasonable number of pipette clamps 104 included. Pipettes may be held by only one pipette clamp 104 or may be held by two or more pipette clamps 104. The pipette clamps 104 are secured to the pipette tray 102 via one or more fasteners 106. It should be appreciated that although the depicted fasteners 106 are screws, any other fastening means may be implemented to secure the one or more pipette clamps 104 to the pipette tray 102, such as soldering, clips, nails, hooks, brackets, bolts, or any other reasonable fastening means may be used.

As can be seen from FIG. 1, there are four rows of the pipette clamps 104 in the pipette tray 102, and the pipette clamps 104 of each row are substantially aligned horizontally on the pipette tray 102. Also, there are fifteen columns of the pipette clamps 104 in the pipette tray 102, and the pipette clamps 104 of each column are substantially aligned vertically on the pipette tray 102. It should be appreciated that although there are four rows and fifteen columns of pipette clamps 104, there may be any reasonable number of rows and columns of pipette clamps, depending on the size of the pipette tray 102, the size of the pipette clamps 104 themselves, or the width or length of the pipettes being held by the pipette clamps 104. Moreover, the pipette clamps 104 of the inner two rows (of seven pipette clamps 104 each) are positioned substantially laterally between the pipette clamps 104 of the outer two rows (of eight pipette clamps 104 each). In other words, the pipette clamps 104 may be in a staggered arrangement to maximize the number of pipette clamps 104, and accordingly, the number of pipettes (not depicted in FIG. 1), that can be included in the pipette tray 102. However, it should be appreciated that any arrangement of pipette clamps 104 on the pipette tray 102 may be implemented, depending on testing goals.

The tray 102 of FIG. 1 may further include arms 108. The arms 108 may be for the purposes of a user to handle the tray 102. The arms 108 may be present on one or both ends of the tray 102 and also may be present on one or both sides of the tray 102 (the top side of the tray 102 is currently viewable in FIG. 1, therefore there may be embodiments in which there are arms 108 on the bottom side of the tray 102 but simply not depicted in FIG. 1). Tray components 100 of the oven mixing apparatus of FIG. 1 may further include a rotor connector 110, designed specifically to connect the tray 102 to a shaft of a rotor (not illustrated in FIG. 1), in order for the tray 102 and pipettes to be rotated within the oven mixing apparatus. Tray components 100 may also include a knob 112 that may be used to manually rotate or otherwise move the tray 102. Furthermore, tray components 100 may include one or more bars 114 that may be used to attach or connect the tray 102 to the inner wall of the oven. The one or more bars 114 may function to keep the tray 102 steady as it rotates within the oven mixing apparatus and to prevent wobbling, bending, or other undesirable movement of the tray 102.

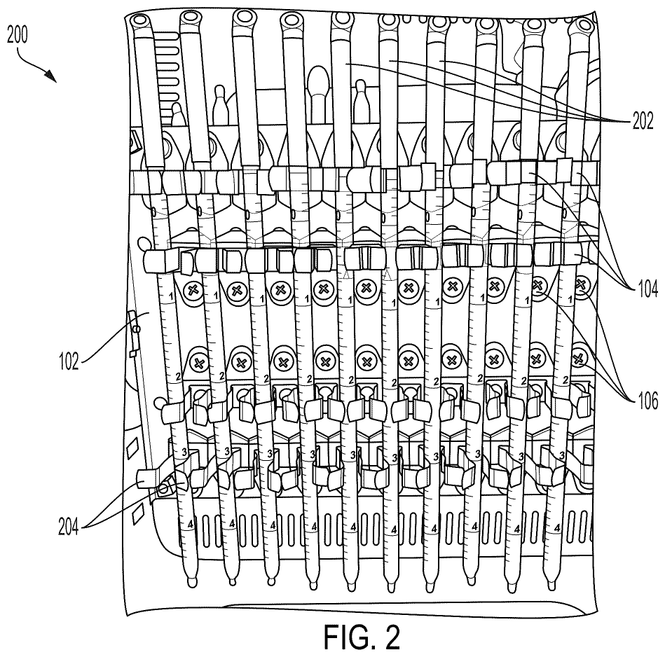

FIG. 2 is a top perspective view of an interior of an oven mixing apparatus 200. Various components have been removed for simplicity with the present discussion, but additional components may be used in conjunction with the interior of the oven mixing apparatus 200 as well. As was illustrated in FIG. 1, the pipette tray 102 of FIG. 2 includes pipette clamps 104 attached to the pipette tray 102 via fasteners 106. Held in the pipette clamps 104 are one or more pipettes 202. It should be appreciated that although there are ten pipettes 202 in the pipette tray 102 of the embodiment illustrated in FIG. 2, there may be any reasonable number of pipettes 202 included. The number of pipettes 202 included in the pipette tray 102 may be constrained by the number of pipette clamps 104, the size of the pipette tray 102, or the width or length of the pipettes 202 themselves.

In some embodiments, each pipette 202 may be positioned substantially in the middle of one or more pipette clamps 104 while also positioned substantially laterally to the side of one or more other pipette clamps 104. This positioning is illustrated in FIG. 2, and is a factor of the staggered arrangement of pipette clamps 104 that was discussed above in regards to FIG. 1. Each pipette 202 may be contacted by one or both clamp claws 204 of an individual pipette clamp 104. Furthermore, each pipette 202 may be contacted by an inside of the clamp claw 204 of an individual pipette clamp 104, while being contacted by the outside of a different clamp claw 204 of a different pipette clamp 104. Additionally, each pipette 202 may be contacted by the inside of the clamp claw 204 of two or more pipette clamps, and each pipette 202 may also be contacted by the outside of the clamp claw 204 of two or more pipette clamps. It should be appreciated that more points of contact of the pipettes 202 to the clamp claws 204 may increase the stability and security of the pipettes 202 being held by the pipette clamps 104, and may ensure the pipettes 202 remain secured to the pipette tray 102 if the pipette tray 102 were to be rotated, shaken, or otherwise moved. It should also be appreciated that, in the embodiments illustrated in FIGS. 1 and 2, each pipette clamps 104 has two clamp claws 204, the pipette clamps 104 may have any reasonable number of clamp claws 204, depending on the design of the pipette clamp 104.

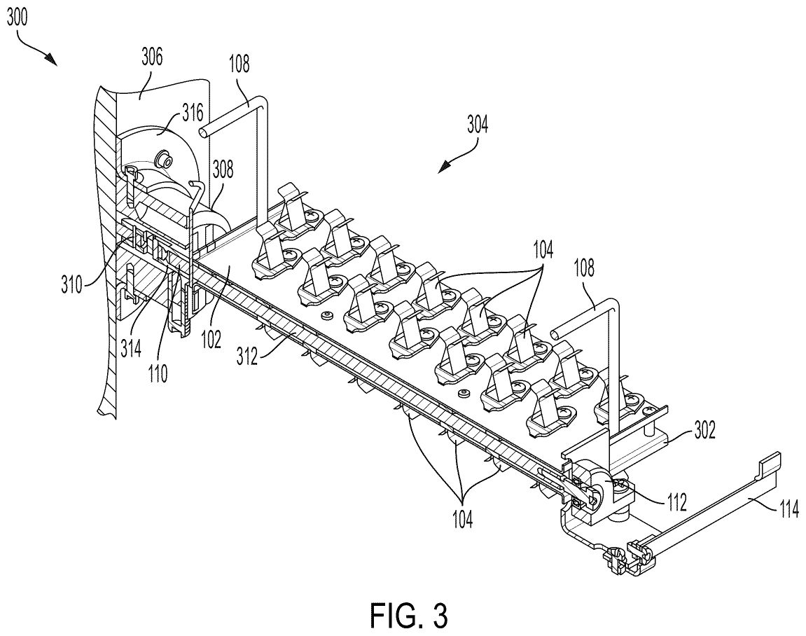

FIG. 3 is an isometric cross-sectional view of interior components of an oven mixing apparatus 300. The cross-sectional view of FIG. 3 is that in which the pipette tray 102 and other components are cut horizontally. As can be seen, components related to the pipette tray 102 of FIG. 1 are reproduced in FIG. 3, such as the arms 108, bars 114, and pipette clamps 104, among others. The embodiment of the interior components of the oven mixing apparatus 300 includes a first pipette tray 102 and a second pipette tray 302, which is on the bottom side the first pipette tray and has similar pipette clamps 104. The embodiment of FIG. 3 illustrates an interior 304 of the oven mixing apparatus 300, as well as an inner wall 306 of the oven mixing apparatus 300. It should be appreciated that although just one inner wall 306 is illustrated in FIG. 3, there may be more than one inner wall 306. For example, in an embodiment, there are four inner walls 306.

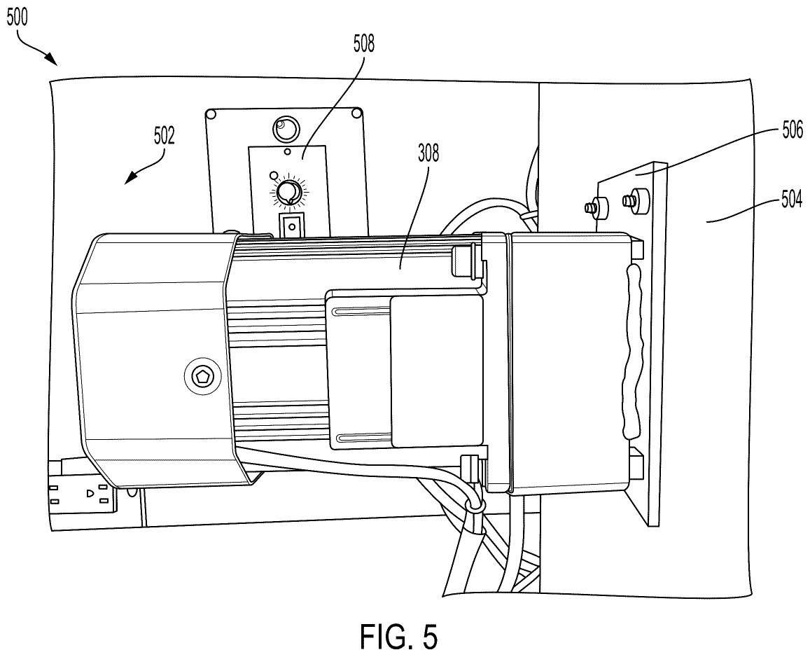

The interior components of the oven mixing apparatus 300 further include a motor 308 that includes a shaft 310. The shaft 310 connects to the pipette tray 102 via the rotor connector 110 attached to the pipette axle 312. The rotor connector 110 may connect to a shaft axle U-joint 314 of the shaft 310 using a threaded connection, snap connection, or another connection means. Accordingly, the shaft axle U-joint 314 and the rotor connector 110 may have mating threaded features. The pipette axle 312 is substantially in the middle of the pipette tray 102 so that when the pipette tray 102 is rotated, the pipette tray is substantially balanced while rotating/spinning about the pipette axle 312. The motor 308 is positioned within an aperture in the inner wall 306 of the oven mixing apparatus 300, such that a portion of the motor 308 is positioned within the interior of the oven mixing apparatus 300 (as depicted in FIG. 3) and a portion of the motor 308 is positioned on the exterior of the oven mixing apparatus 300 (depicted in FIG. 5, and discussed below). The aperture is surrounded by the inner motor flange 316 that functions to secure the motor 308 in the inner wall 306 of the oven mixing apparatus 300. The inner motor flange 316 may also prevent heat from escaping the interior 304 of the oven mixing apparatus 300.

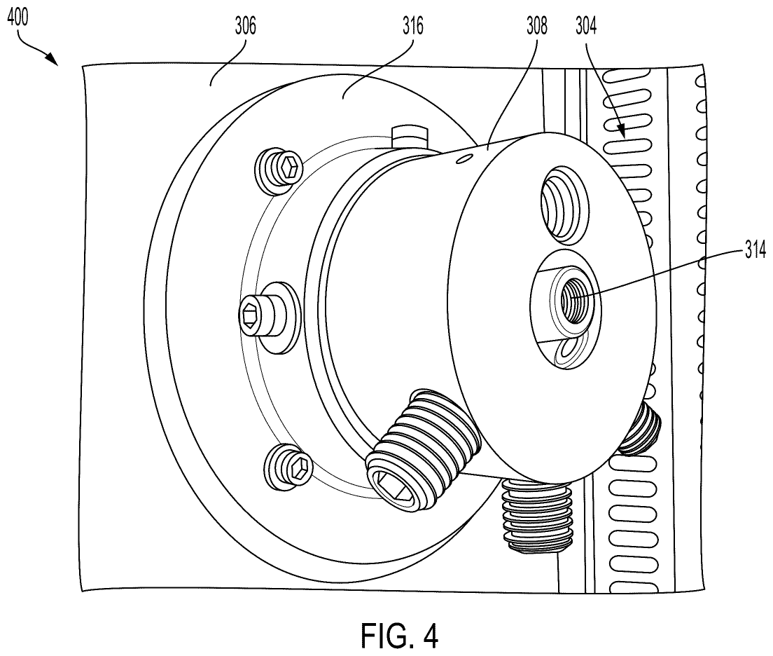

FIG. 4 is a perspective view of interior components of an oven mixing apparatus 400. Various components have been removed for simplicity with the present discussion, but additional components may be used with the oven mixing apparatus 400 as well. As can be seen, FIG. 4 illustrates the interior 304 of the oven mixing apparatus 400 and depicts the inner wall 306, the motor 308, the inner motor flange 316, and the shaft axle U-joint 314 in more detail.

FIG. 5 is a side perspective view of exterior components of an oven mixing apparatus 500. The embodiment of FIG. 5 illustrates an exterior 502 of the oven mixing apparatus 500, as well as an outer wall 504 of the oven mixing apparatus 500. As can be seen in FIG. 4, the portion of the motor 308 outside of the oven mixing apparatus 500 is extruding from the outer wall 504. On the outer wall 504 is an outer motor flange 506 that functions to secure the motor 308 in the outer wall 504 of the oven mixing apparatus 500. The outer motor flange 506 may also prevent heat from escaping to the exterior 502 of the oven mixing apparatus 500. The functionality of the motor 308 may be controlled by a controller 508 (e.g., a control panel). For example, the controller 508 may control the speed at which the shaft (not depicted in FIG. 5) of the motor 308 rotates, and thus the speed at which the pipette tray (also not depicted in FIG. 5) rotates within the oven mixing apparatus 500. The controller 508 may also control which direction the pipette tray rotates within the oven mixing apparatus and/or how often the rotational direction is switched.

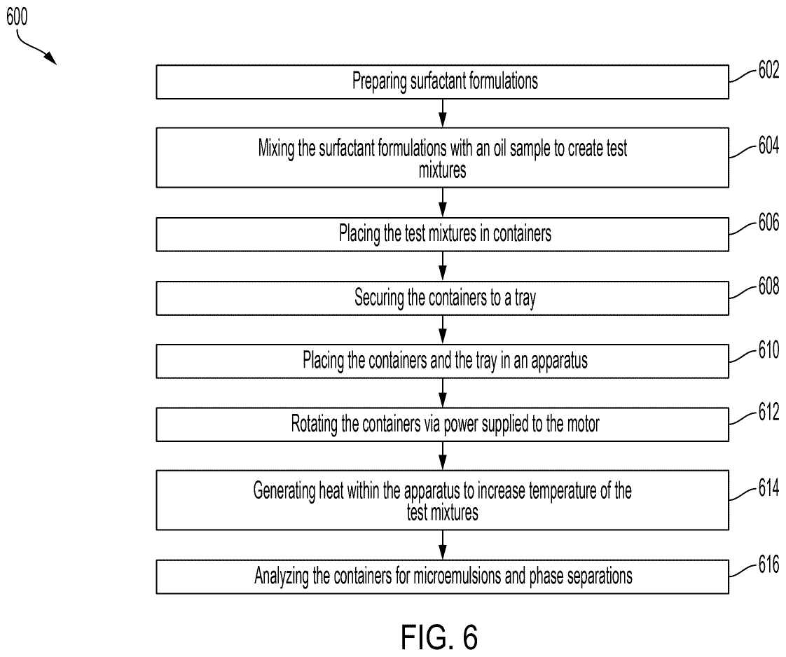

FIG. 6 is a flow chart of a method 600 for performing a phase behavior test. It should be appreciated that steps for the method 600 may be performed in any order, or in parallel, unless otherwise specifically stated. Moreover, the method may include more or fewer steps. In various embodiments, the method 600 may include preparing surfactant formulations 602. The method 600 may also include mixing the surfactant formulations with an oil sample to create test mixtures 604. Further, the method 600 may include placing the test mixtures in containers 606, and the method 600 may include securing the containers to a tray 608. Additionally, the method 600 may include placing the containers and the tray in an apparatus that comprises a motor 610. In some embodiments, a shaft of the motor is attachable to the tray. The method 600 may also include rotating the containers via power supplied to the motor 612. Moreover, the method 600 may include generating heat within the apparatus to increase temperature of the test mixtures 614. Furthermore, the method 600 may include analyzing the containers to determine whether the containers comprise microemulsions and may also include analyzing phase separations in the containers 616.

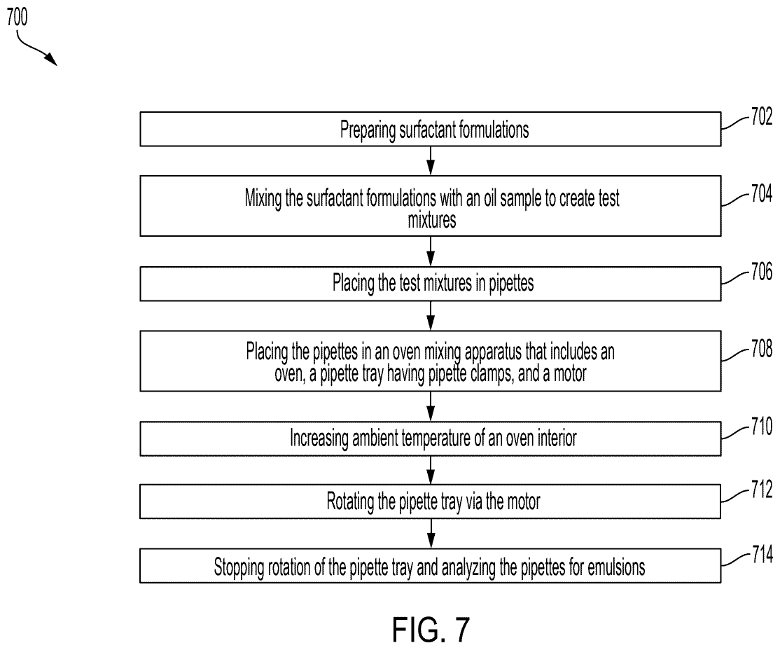

FIG. 7 is a flow chart of a method 700 using an oven mixing apparatus. It should be appreciated that steps for the method 700 may be performed in any order, or in parallel, unless otherwise specifically stated. Moreover, the method may include more or fewer steps. In various embodiments, the method 700 may include preparing surfactant formulations 702. The method 700 may also include mixing the surfactant formulations with an oil sample to create test mixtures 704. Further, the method 700 may include placing the test mixtures in pipettes 706. Additionally, the method 700 may include placing the pipettes in an oven mixing apparatus 708. In some embodiments, the oven mixing apparatus includes an oven, a pipette tray having pipette clamps, and a motor. The method 700 may also include increasing ambient temperature of an interior of the oven 710. Furthermore, the method 700 may include rotating the pipette tray via the motor 712. Moreover, the method 700 may include stopping the rotation of the pipette tray and analyzing the pipettes 714. The stopping of the rotation of the pipette tray and the analyzing of the pipettes 714 may include observing whether microemulsions or macroemulsions have formed and taking readings of volumes of oil phase, water phase, and emulsion phase.

### EXAMPLES

The following example is an exemplary embodiment and is not meant to limit the scope of the disclosure.

### Example 1

Liquid samples including brine solution, surfactant stock solution, and crude oil (or synthetic oil, or surrogate oil) were prepared. Pipettes were sealed at the sharp tip sides of the pipettes, then the pipettes were filled with the aqueous solutions (i.e., not including the crude oil). Once filled with the aqueous solutions, the aqueous levels of the samples were recorded. Then, the crude oil was added into the pipettes, the pipettes were sealed on the side opposite the sharp tip side, and the levels of the oil in the pipettes were recorded. All pipettes were labeled according to the contents of the individual pipettes. The pipettes were placed in an oven mixing apparatus to continuously mix the contents of the pipettes while heating the contents of the pipettes. Continuous mixing of the contents of the pipettes help evenly distribute the oil, brine, and surfactant to form emulsions. The temperature of the oven mixing apparatus was set to 92 degrees Celsius. After 1 hour of mixing in the oven mixing apparatus and 1 hour of letting the samples settle, Type III microemulsions had already formed. Once the samples underwent 24 hours without any shifts in the oil, brine, and microemulsion levels, they were determined to be at equilibrium. The samples were analyzed for microemulsions or macroemulsions, and readings were taken of volumes of oil phase, water phase, and microemulsion phase. The time it took for the samples to reach equilibrium was about 8 or 9 days.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. An oven mixing apparatus, comprising:
an oven comprising an oven interior and an oven exterior, the oven capable of generating heat;
a pipette tray positioned in the oven interior, the pipette tray comprising:
one or more pipette clamps attached to the pipette tray via one or more fasteners;
one or more arms; and
a pipette tray axle; and
a motor, comprising:
an internal motor portion positioned in the oven interior;
an external motor portion positioned in the oven exterior;
a rotor
a shaft, the shaft being rotatable via the rotor; and
a controller capable of controlling rotational speed of the shaft;
wherein the pipette tray axle is securable to the shaft of the motor, and wherein rotation of the shaft induces rotation of the pipette tray.

2. The oven mixing apparatus of claim 1, wherein the oven is capable of creating temperatures up to approximately 400 degrees Fahrenheit.

3. The oven mixing apparatus of claim 1, wherein the pipette tray is capable of tolerating temperatures up to approximately 400 degrees Fahrenheit.

4. The oven mixing apparatus of claim 1, wherein the motor is capable of rotating the pipette tray at approximately 2 revolutions per minute to approximately 15 revolutions per minute.

5. A method for performing a phase behavior test, comprising:
preparing one or more surfactant formulations;
mixing the one or more surfactant formulations with an oil sample to create one or more test mixtures;
placing the one or more test mixtures in one or more containers;
securing the one or more containers to a tray;
placing the one or more containers and the tray in an apparatus comprising a motor, wherein the motor comprises a rotor, and wherein a shaft of the rotor is attachable to the tray;
rotating the one or more containers via power supplied to the motor;
generating heat within the apparatus to increase temperature of the one or more test mixtures;
analyzing the one or more containers to determine whether the one or more containers comprise microemulsions; and
analyzing phase separations in the one or more containers.

6. The method for performing a phase behavior test of claim 5, further comprising:
mixing the one or more test mixtures in the one or more containers.

7. The method for performing a phase behavior test of claim 5, wherein the apparatus is capable of creating temperatures up to approximately 400 degrees Fahrenheit.

8. The method for performing a phase behavior test of claim 5, wherein the one or more containers are capable of tolerating temperatures up to approximately 400 degrees Fahrenheit.

9. The method for performing a phase behavior test of claim 5, wherein the motor further comprises a controller to control rotational speed of the shaft.

10. The method for performing a phase behavior test of claim 9, further comprising:
rotating the tray at approximately 2 revolutions per minute to approximately 15 revolutions per minute.

11. The method for performing a phase behavior test of claim 5, wherein the one or more test mixtures further comprise salt, water, and gas.

12. The method for performing a phase behavior test of claim 5, further comprising:
sealing the one or more containers.

13. A method of using an oven mixing apparatus, comprising:
preparing one or more surfactant formulations;
combining the one or more surfactant formulations with an oil sample to create one or more test mixtures;
placing the one or more test mixtures in one or more pipettes;
placing the one or more pipettes in the oven mixing apparatus, wherein the oven mixing apparatus comprises:
an oven comprising an oven interior and an oven exterior;
a pipette tray positioned in the oven interior, the pipette tray comprising one or more pipette clamps attached to the pipette tray, wherein the one or more pipettes are secured to the one or more pipette clamps; and
a motor comprising an internal motor portion positioned in the oven interior and an external motor portion positioned in the oven exterior;
increasing ambient temperature of the oven interior; and
rotating the pipette tray via a rotor of the motor.

14. The method of using an oven mixing apparatus of claim 13, further comprising:
mixing the one or more test mixtures in the one or more containers.

15. The method of using an oven mixing apparatus of claim 13, wherein the oven mixing apparatus is capable of creating temperatures up to approximately 400 degrees Fahrenheit.

16. The method of using an oven mixing apparatus of claim 13, wherein the one or more test mixtures are capable of tolerating temperatures up to approximately 400 degrees Fahrenheit.

17. The method of using an oven mixing apparatus of claim 13, wherein the motor further comprises:
a shaft rotatable by the rotor of the motor; and
a controller to control rotational speed of the shaft.

18. The method of using an oven mixing apparatus of claim 17, wherein the motor rotates the tray at approximately 2 revolutions per minute to approximately 15 revolutions per minute.

19. The method of using an oven mixing apparatus of claim 13, wherein the one or more test mixtures further comprise salt, water, and gas.

20. The method of using an oven mixing apparatus of claim 13, further comprising:
sealing the one or more pipettes.
